(19) United States
(12) Patent Application Publication
(10) Pub. No.: US 2004/0205337 A1
(43) Pub. Date: Oct. 14, 2004

(54) Digital message signature and encryption

(76) Inventors: Wenbo Mao, Stoke (GB); John Malone-Lee, Clifton (GB)

Correspondence Address: HEWLETT-PACKARD COMPANY, Intellectual Property Administration, P.O. Box 272400, Fort Collins, CO, 80527-2400, US

(21) Appl. No.: 10/729,299

(22) Filed: Dec. 5, 2003

(30) Foreign Application Priority Data
Apr. 10, 2003 (GB) 0308305.2

(51) Int. Cl. H04L 9/00

(52) U.S. Cl. 713/160

(57) ABSTRACT

Signcryption methods and apparatus are provided that combine the functions of signing and encrypting data to obtain private and authenticated communications. The signcryption methods are based on RSA and permit compact ciphertexts to be produced and non-repudiation to be provided in a straightforward manner.

### FIELD OF THE INVENTION

The present invention relates to methods and apparatus for implementing a signcryption cryptographic scheme A “signcryption” scheme is one that combines both signing and encrypting data to obtain private and authenticated communications

### BACKGROUND OF THE INVENTION

Signcryption is a novel public key primitive first proposed by Zheng in 1997 in the paper: “Digital Signcryption or How to Achieve Cost(Signature & Encryption)<<Cost(Signature)+Cost(Encryption).” in Advances in Cryptology—CRYPTO '97, volume 1294 of Lecture Notes in Computer Science, pages 165-179, Springer-Verlag, 1997. The scheme described in that paper is also described in U.S. Pat. No. 6,396,928.

A signcryption scheme combines the functionality of a digital signature scheme with that of an encryption scheme. It therefore offers the three services: privacy, authenticity and non-repudiation. Since these services are frequently required simultaneously, Zheng proposed signcryption as a means to offer them in a more efficient manner that a straightforward composition of digital signature scheme and encryption scheme.

The present invention relates to a provably secure signcryption scheme and, in particular, a signcryption scheme based on the RSA trapdoor one-way function

The RSA public key cryptographic method is well known and in its basic form is a two-party method in which a first party generates a public/private key pair and a second party uses the first party's public key to encrypt messages for sending to the first party, the latter then using its private key to decrypt the messages. More particularly, and with reference to FIG. 1 of the accompanying drawings, in the basic RSA encryption method the following operational steps are carried out by a message sender A and a message recipient B acting through respective computing entities 10 and 11:

Initial Set Up Phase

1. B chooses distinct random primes p and q.

2 B computes N=(p).(q) and φ=(p−1).(q−1).

3. B selects an encryption exponent e such that e and φ have no common factors.

4. B computes a decryption exponent d=1/e mod φ

5. B publishes both e and N as its public key and keeps d secret as its private key (p and q are either destroyed or also kept secret)

Message Transfer Phase

6. A generates a message m.

7. A computes m^{e} mod N and sends this to B.

8. computes (m^{e})^{d} mod N to recover m.

The set up phase is carried out once whilst the message transfer phase is carried out for each message to be sent from A to B. In practice, the set up phase may be carried out on behalf of B by a certificate authority that provides a trustable certificate associating B to its public key <e,N> and communicates d securely to B; the value of e is fixed for any particular domain.

### SUMMARY OF THE INVENTION

According to one aspect of the present invention, there is provided a method by which a first computing entity having an RSA key pair (N_{A},e_{A}), (N_{A},d_{A}) digitally signs and encrypts a message data string, m, for decryption by a second computing entity having an RSA key pair (N_{B}, e_{B}), (N_{B}, d_{B}), where |N_{A}|=|N_{B}|=k and mε{0,1}ⁿ, and k=n+k₀+k₁ for integers k₀ and k₁, the method comprising:

a) selecting an integer rε{0,1}^{k}^{₀},

b) computing:

w←A H(C₁(at least m and r))

where H: {0,1}^{n+k}^{₀}→{0,1}^{k}^{₁}, and C₁( ) is a deterministic combination function,

c) computing:

s←Enc(w, C₂(at least m and r)

where Enc( ) is a symmetric-key encryption function using w as key, and C₂( ) is a reversible combination function;

steps a) to c) being repeated as necessary to obtain s∥ω≦N_{A}; and then

d) signing by computing:

c′←(C₃(at least s and w))^{d}^{_{A}} mod N_{A}

where C₃( ) is a reversible combination function; and

e) if c′≦N_{B}, encrypting c′ by computing:

c=c′^{c}^{_{B}} mod N_{B}.

According to another aspect of the present invention, there is provided a method by which a second computing entity having an RSA key pair (N_{B}, e_{B}). (N_{B}, d_{B}), decrypts and authenticates a signed and encrypted version c of a message data string, m, provided by a first computing entity having an RSA key pair (N_{A},e_{A}), (N_{A},d_{A}) where |N_{A}|=|N_{B}|=k and mε{0,1}ⁿ, and k=n+k₀+k₁ for integers k₀ and k₁; the second computing entity on receiving c:

(a) computing:

c′←c^{d}^{_{B}} mod N_{B},

and proceeding to the next step provided that c′≦N_{A};

(b) computing:

c′^{e}^{_{A}} mod N_{A}

with at least quantities s and w being recovered from the result;

(c) computing:

Dec(w, s)

where Dec( ) is a symmetric-key decryption function complimenting Enc( ), with at least quantities m and r being recovered from the result;

(d) verifying that the message m is from the first computing entity by checking that:

w=H(C₁(at least m and r))

where H:{0,1}^{n+k}^{₀}→{0,1}^{k}^{₁}, and C₁( ) is a deterministic combination function.

Preferably, r is selected at random.

The present invention further envisages apparatus for implementing the foregoing methods, and computer-readable media storing program code for controlling a computer to implement the foregoing methods.

An attractive feature of the scheme of the present invention is that it offers non-repudiation in a very simple manner. Non-repudiation for signcryption is not a straightforward sequence of unforgeability like it is for digital signature schemes. The reason for this is that a signcrypted message is “encrypted” as well as “signed”. Therefore, by default, only the intended receiver of a signcryption may verify its authenticity. If a third party is to settle a repudiation dispute over a signcryption, it must have access to some information in addition to the signcryption itself. Of course the receiver could always surrender its private key but this is clearly unsatisfactory. It is often the case that several rounds of zero-knowledge are required; however, for embodiments of the present invention this is not necessary.

Embodiments of the present invention advantageously use a padding scheme similar to the PSS padding scheme that was originally designed to create a provably secure signature algorithm when used with RSA (see “The Exact Security of Digital Signatures—How to sign with RSA and Rabin” M. Bellare and P Rogaway, in Advances in Cryptography—EUROCRYPT '96, volume 1070 of Lecture Notes in Computer Science, pages 3399-416, Springer-Verlag, 1996). It was subsequently pointed out that a version of PSS could also be combined with RSA to create a provably secure encryption function (see “Universal Padding Schemes for RSA” J-S Coron, M. Joye, D. Naccache, P. Paillier, in Advances in Cryptography—CRYPTO 2002, volume 2442 of Lecture Notes in Computer Science, pages 226-241, Springer-Verlag, 2002). This makes PSS padding well suited for RSA-based signcryption. Embodiments of the present invention can be designed that are very efficient in terms of bandwidth giving, for example, signcrypted messages that are half the size of a message signed and encrypted using standard techniques for RSA.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating the operational steps of the well-known basic RSA cryptographic method;

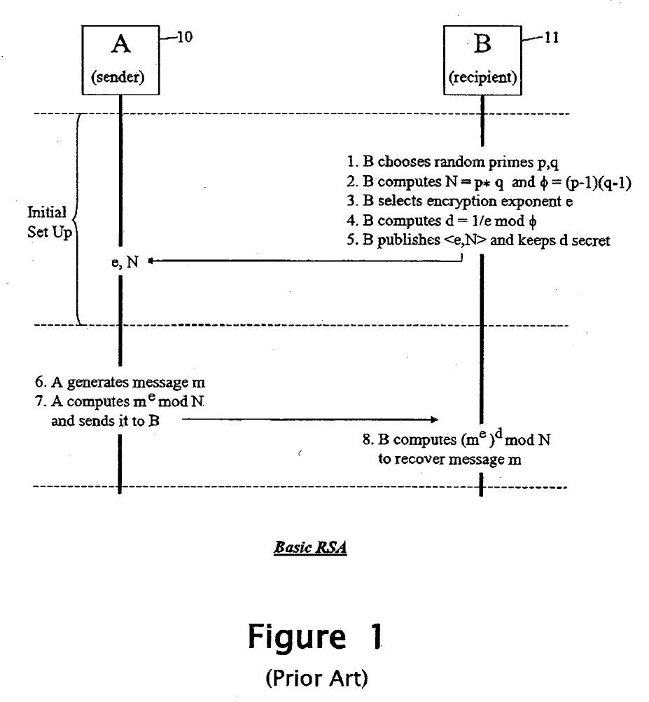

FIG. 2 is a schematic diagram of a system of cooperating computer entities for effecting signcryption methods embodying the present invention;

FIG. 3 is a schematic diagram of the computing entities of the system of FIG. 2;

FIG. 4 is a high level description of a first signcryption method embodying the present invention;

FIG. 5 is a high level decryption of a decryption and authentication method for use in respect of a message signcrypted according to the FIG. 4 method; and

FIG. 6 is a high level description of a second signcryption method embodying the present invention

### BEST MODE OF CARRYING OUT THE INVENTION

In the following description numerous specific details are set forth in order to provide a thorough understanding of the present invention. It will be apparent, however, to one skilled in the art, that the present invention may be practiced without limitation to these specific details. In other instances, well-known methods and structures have not been described in detail so as not to unnecessarily obscure the present invention.

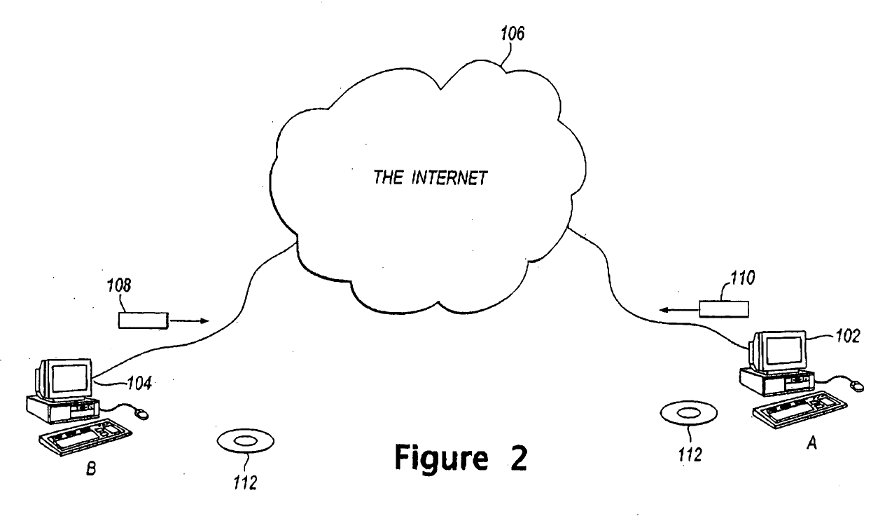

Referring to FIG. 2, there is illustrated schematically two computing entities 102, 104, configured for exchanging electronic data 108, 110 with each other over a communications network in any suitable manner. The first computing entity 102 is hereinafter referred to as entity A or Alice, and the second computing entity 104 is hereinafter referred to as entity B or Bob. In the example illustrated in FIG. 2, the first and second entities A and B are geographically remote from each other and the communications network comprises the public internet 106. In other embodiments and implementations of the present invention the communications network could comprise any suitable means of transmitting digitized data between the computing entities. For example, a known Ethernet network, local area network, wide area network, virtual private circuit or public telecommunications network may form the basis of a communications medium between the entities A and B.

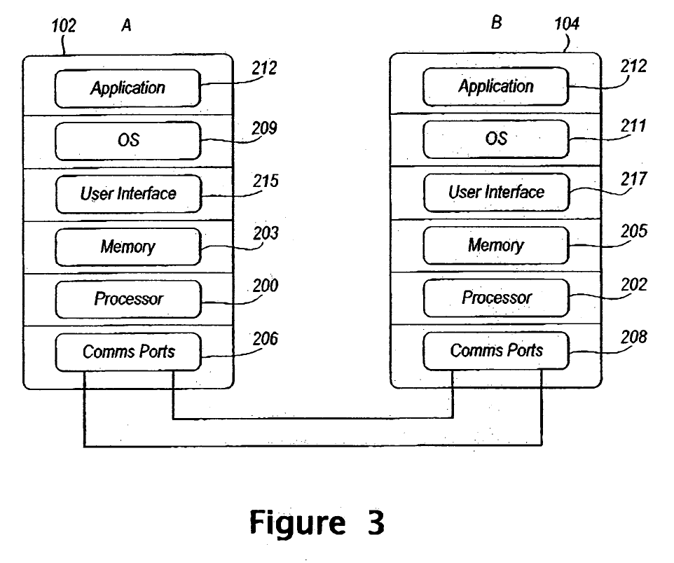

Referring now to FIG. 3, there is illustrated schematically physical resources and logical resources of the computing entities A and B. Each computing entity comprises at least one data processing means 200, 202, a memory area 203, 205 holding program code and data, and a communications port 206, 208. The program code held in memories 203 and 205 comprises, for example, programs read from computer program storage media 112 and 114 (for example a CD-ROM). These programs include an operating system 209, 211 (for example, a known Unix operating system), and one or more applications programs 212 configured for receiving, transmitting and performing data processing on electronic data received from other computing entities, and transmitted to other computer entities in accordance with embodiments of the present invention. Optionally there is a user interface 215, 217 which may comprise a visual display device, a pointing device (for example, a mouse or track-ball device), and a keypad

Two signcryption methods, each embodying the present invention, are described hereinafter. However, the general form of these methods will first be illustrated with reference to an abstract signcryption method that uses what will here be called a permutation-with-trapdoors. A permutation-with-trapdoors f:{0,1}^{k}→{0,1}^{k} is a function that requires some secret, or “trapdoor”, information to evaluate and some different secret information to perform the inverse function f¹. In the following description of this abstract scheme it will be assumed that the sender of messages, Alice, knows the secret information necessary to evaluate f, and the receiver, Bob, knows the secret information necessary to evaluate f¹.

The abstract signcryption scheme can be used to signcrypt messages from {0,1}ⁿ, where k=n+k₀+k₁ for integers k₀ and k₁. Before f is applied to a message some random padding is applied. The padding used is similar to the afore-mentioned PSS. The astract signcryption scheme is as follows:

Parameters

The scheme uses two hash functions:

H: {0,1}^{n+k}^{₀}→{0,1}^{k}^{₁} and G: {0,1}^{k}^{₁}→{0,1}^{n+k}^{₀}.

Signcryption

For Alice to signcrypt a message mε{0,1}ⁿ for Bob:

(i) Alice chooses a random value r:

$$r {⟵}^{r} {\{ 0 , 1 \}}^{{k}_{0}}$$

(ii) Alice computes:

ω←H(m∥r)

where ∥represents sting concatenation.

(iii) Alice computes

s←G(ω)⊕(m∥r)

where ⊕ is the Exclusive OR function

(iv) Alice computes

c←f(s∥ω)

(v) Alice sends c to Bob

Unsigncryption

For Bob to unsigncrypt (decrypt and authenticate) a cryptogram c from Alice:

(i) Bob computes

s∥ω←f⁻¹(c)

(ii) Bob next computes

m∥r←G(ω)⊕s

to complete decryption and recover m

(iii) Bob then carries out authentication by checking if:

H(m∥r)=ω

If this check is passed, m is accepted as coming from Alice; otherwise, m is rejected

For the foregoing signcryption method, there is no obvious way to provide non-repudiation.

In the embodiments of the present invention, RSA is used to create something like a permutation-with-trapdoors—however, it is not claimed, nor is it necessary, that the resulting function is a permutation.

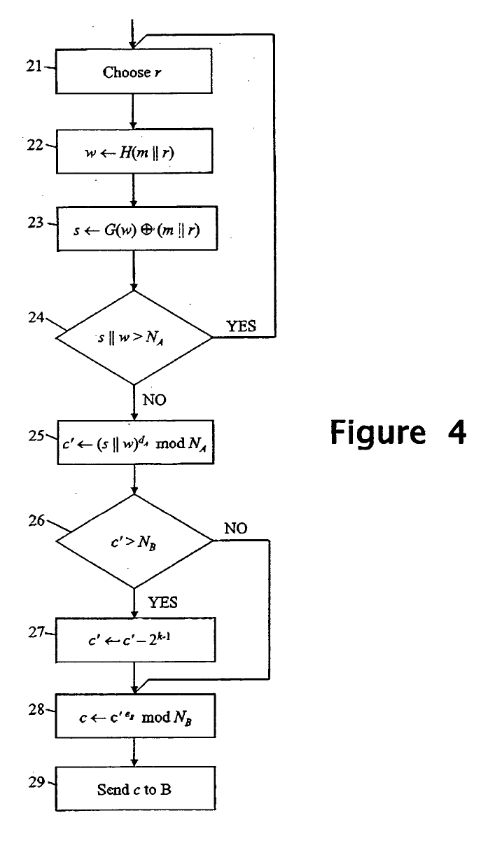

Referring now to FIG. 4, there is shown a pseudo-code flow description of the steps of a first embodiment of the invention by which Alice signcrypts a message, m, for transmittal to Bob.

It is assumed that sender Alice has generated an RSA public/private key pair (N_{A},e_{A}); (N_{A},d_{A}), with N_{A}=P_{A}·Q_{A} and |P_{A}|=|Q_{A}|=k/2. Here and henceforth k is an even positive integer. Bob is assumed to have done likewise giving him an RSA public/private key pair (N_{B},e_{B}), (N_{B},d_{B}). G and H are as described above. The step numbering in square brackets refers to the function blocks in FIG. 4.

Signcryption

For Alice to signcrypt a message mε{0,1}ⁿ for Bob:

[21] Alice chooses a random number r

$$r {⟵}^{r} {\{ 0 , 1 \}}^{{k}_{0}}$$

[22] Alice computes:

ω←H(m∥r)

[23] Alice computes:

s←G(ω)⊕(m∥r)

[24] Alice then checks whether

s∥w>N_{A}

If this is true, then the signcryption process is re-started at step 21 with a different value of r being chosen; otherwise, processing continues.

[25] Alice signs by computing:

c′←(s∥ω)^{d}^{_{A}} mod N_{A}

[26] Alice checks whether.

c′>N_{B}

If this is true, then step 27 is performed next; otherwise, step 27 is skipped.

[27] Alice computes:

c′←c′−2^{k-I}

[28] Alice encrypts by computing:

c←c′^{d}^{_{B}} mod N_{B}

[29] Alice sends c to Bob

Unsigncryption

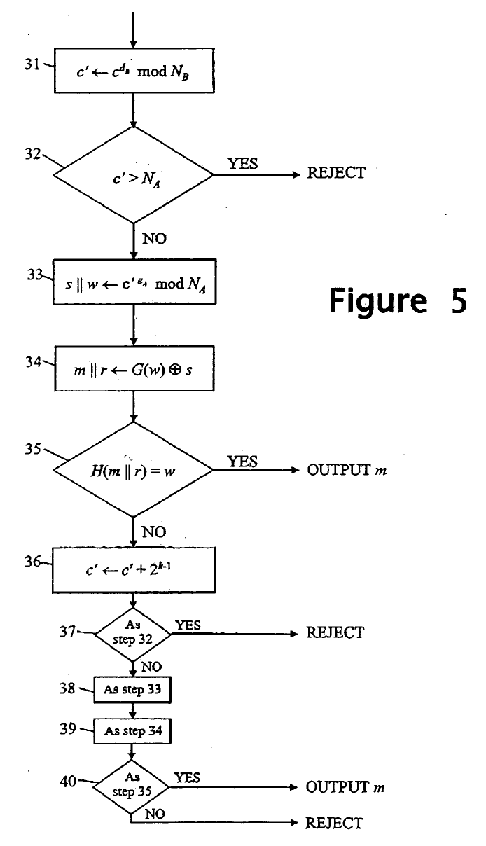

The unsigncryption process performed by Bob on the cryptogram c from Alice is illustrated in FIG. 5 and comprises the following steps (the step numbering in square brackets referring to the corresponding function blocks of FIG. 5):

[31] Bob computes:

c′←c^{d}^{_{B}} mod N_{B}

[32] Bob carries out the check:

c′>N_{A}

If true, then the process is stopped and c rejected; otherwise, the process continues

[33] Bob computes:

μ←c′^{d}^{_{A}} mod N_{A}

and parses μ as s∥ω

[34] Bob then computes:

m∥r←G(ω)⊕s

[35] Bob carries out the check:

H(m∥r)=w

If true, m is output and the process terminates; otherwise step 36 is carried out next.

[36] Bob computes:

c′←c′+2^{k-1}

[37-40] Bob now carries out steps 37 to 40 which respectively correspond to steps 32 to 35 but for the new value of c′; however, if the check carried out in step 40 fails, then processing is terminated and the cryptogram c rejected

The purpose of steps 26 and 27 in the FIG. 4 signcryption process is to ensure that c′<N_{B}. If c′ initially fails this test then: N_{A}>c′>N_{B}. Since both N_{A} and N_{B} have k-bits, it is possible to infer that c′ also has k-bits and so the assignment c′←c′−2^{k-1} is equivalent to removing the most significant bit of c′. This gives c′<N_{d} as required.

However, this step may cause additional steps in the unsigncryption process—in particular it may be necessary to repeat steps 32-35 (as steps 37 to 40) resulting in the operation of c′^{c}^{_{A}} mod N_{A} being effected twice (with respective values of c′ that differ by 2^{k-1}).

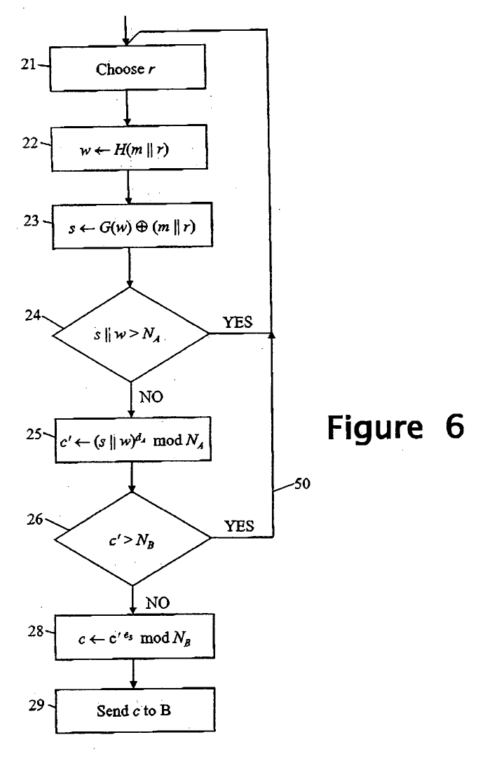

In fact, it is possible to implement a different version of the overall process in which step repetition occurs in the signcryption process rather than in the unsigncryption process. FIG. 6 illustrates the signcryption process for such an alternative implementation. As can be seen from FIG. 6, the signcryption process is similar to that of FIG. 4 but now if in step 26 it is found that c′>N_{B} then instead of the most significant bit of c′ being removed, the signcryption process is restarted at step 21. In other words, steps 21-25 are repeated with different values of r until c′<N_{B} is obtained. Where the FIG. 6 signcryption process is used, then the unsigncryption process can be constituted by steps 31 to 35 with failure of the check in step 35 resulting in termination of the process and rejection of the cryptogram c.

Non-repudiation is very simply effected for the signcryption processes of FIGS. 4 and 6. The receiver of a signcrypted message follows the unsigncryption process (FIG. 5) and provided that in step 32 c′>N_{A} is found not to be true, the value of c′ available at that step can then be given to a third party who can verify its validity.

A full description of the security proofs regarding the above-described signcryption and unsigncryption embodiments, is given in the paper, herein incorporated by reference, “Two Birds One Stone: Signcryption using RSA” by Wenbo Mao and John Malone-Lee, available Dec. 6, 2002 from Hewlett-Packard's website and subsequently available in Topics in Cryptography—Cryptographers Track, RSA Conference 2003, Lecture Notes in Computer Science 2612, pages 210-224, Springer, 2003.

It will be appreciated that many variants are possible to the above described embodiments of the invention. For example, in step 23 of the signcryption methods of FIGS. 4 and 6, the computation:

G(w)⊕(m∥r)

can be replaced by any symmetric-key encryption process Enc(w, m∥r) taking w as the encryption key for encrypting the string (m∥r); any deterministic processing carried out on w before it is used in the underlying encryption algorithm is taken to reside in Enc( ). In this case, in the unsigncrypt process the corresponding computation:

G(w)⊕s

is replaced by the corresponding symmetric-key decryption operation Dec(w, s) using w as the key.

It will be appreciated that the order of concatenation of concatenated components does not matter provided this is known to both entities A and B. Indeed, these components can be combined in ways other than by concatenation. Thus, the concatenation carried out in steps 22 and 35 can be replaced by any deterministic combination function, whilst the concatenation carried out in step 23 and reversed in step 34 can be replaced by any combination function that is reversible, as also can the concatenation carried out in step 25 and reversed in step 33. It is also possible to include additional components into the set of components subject to combination.

It will be further appreciated that the message m can comprises any subject data including text, an image file, a sound file, an arbitrary string, etc

Potential usages of the above-described embodiments include signcrypting a bankcard payment authorization, and signrypting session keys in a key transport protocol.

1. A method by which a first computing entity having an RSA key pair (N_{A},e_{A}), (N_{A},d_{A}) digitally signs and encrypts a message data string, m, for decryption by a second computing entity having an RSA key pair (N_{B},e_{B}), (N_{B},d_{B}), where |N_{A}|=|N_{B}|=k and mε{0,1}ⁿ, and k=n+k₀+k₁ for integers k₀ and k₁, the method comprising:
a) selecting an integer rε{0,1}^{k}^{₀},
b) computing:
w←H(C₁(at least m and r))
where H: {0,1}^{n+k}^{₀}→{0,1}^{k}^{₁}, and C₁( ) is a deterministic combination function,
c) computing:
s←Enc(w, C₂(at least m and r))
where Enc( ) is a symmetric-key encryption function using w as key, and C₂( ) is a reversible combination function;
steps a) to c) being repeated as necessary to obtain s∥ω≦N_{A}; and then
d) signing by computing:
c′←(C₃(at least s and w))^{d}^{_{A}} mod N_{A}
where C₃( ) is a reversible combination function; and
e) if c′≦N_{B}, encrypting c′ by computing:
c=c′^{e}^{_{B}} mod N_{B}.

2. A method according to claim 1, wherein if c′>N_{B} following step d), the most significant bit of c′ is removed to obtain a new c′ which is then encrypted by computing:
c=c′^{c}^{_{B}} mod N_{B}.

3. A method according to claim 1, wherein if c >N_{B} following step d), steps a) to d) are repeated as necessary to obtain c′≦N_{B} whereupon c′ is encrypted by computing:
c=c′^{c}^{_{B}} mod N_{B}

4. A method according to claim 1, wherein r is selected at random.

5. A method according to claim 1, wherein the function C₁( ) is a concatenation function.

6. A method according to claim 1, wherein the function C₂( ) is a concatenation function.

7. A method according to claim 1, wherein the function C₃( ) is a concatenation function.

8. A method according to claim 1, wherein the functions C₁( ), C₂( ), C₃( ) are all concatenation functions.

9. A method according to claim 1, wherein the symmetric-key encryption function Enc( ) effects at least the following operations:
forming a hash of the key w;
forming an exclusive-OR of the hash of w with the output of the combination function C₂( ).

10. Apparatus for carrying out the method of claim 1.

11. A computer-readable medium storing a computer program arranged to condition a program-controlled computer, when executed by the latter, to carry out the method of claim 1.

12. A method according to claim 1, wherein the second computing entity on receiving c:
(f) computes:
c′←c^{d}^{_{B}} mod N_{B}
and, provided c′≦N_{A}, proceeds to the next step;
(g) computes:
c′^{e}^{_{A}} mod N_{A}
with the result being subject to a reverse of the combination function C₃( ) whereby to recover at least: s and w;
(h) computes:
Dec(w, s)
where Dec( ) is a symmetric-key decryption function complimenting Enc( ), with the result being subject to a reverse of the combination function C₂( ) whereby to recover at least: m and r;
(i) checks that the message m is from the first computing entity by checking that:
w=H(C₁(at least m and r)).

13. A system comprising a first computing entity, a second computing entity, and a communications network for communicating the first and second entities, the system being arranged to implement the method of claim 12.

14. A method according to claim 2, wherein the second computing entity on receiving c:
(f) computes:
c′←c^{d}^{_{B}} mod N_{B},
and, provided c′≦N_{A}, proceeds to the next step;
(g) computes:
c′^{e}^{_{A}} mod N_{A}
with the result being subject to a reverse of the combination function C₃( ) whereby to recover at least: s and w;
(h) computes,
Dec(w, s)
where Dec( ) is a symmetric-key decryption function complimenting Enc( ), with the result being subject to a reverse of the combination function C₂( ) whereby to recover at least: m and r;
(i) checks that the message m is from the first computing entity by checking that:
w=H(C₁(at least m and r));
j) where the check carried out in step (i) fails, computes a new value for c′ as:
c′←c′+2^{k-1}
and, provided c′≦N_{A}, repeats once steps (g) to (i).

15. A system comprising a first computing entity, a second computing entity, and a communications network for communicating the first and second entities, the system being arranged to implement the method of claim 14.

16. A method by which a second computing entity having an RSA key pair (N_{B}, e_{B}), (N_{B}, d_{B}), decrypts and authenticates a ciphertext c that is purportedly a signed and encrypted form produced by a first computing entity of a message data string m, the first computing entity having an RSA key pair (N_{A},e_{A}), (N_{A},d_{A}) where |N_{A}|=|N_{B}|=k and mε{0,1}ⁿ, and k=n+k₀+k₁ for integers k₀ and k₁; the second computing entity on receiving c:
(a) computes:
c′←c^{d}^{_{B}} mod N_{B}
and proceeds to the next step provided that c′≦N_{A};
(b) computes:
c′^{e}^{_{A}} mod N_{A}
with at least quantities s and w being recovered from the result;
(c) computes:
Dec(w,s)
where Dec( ) is a symmetric-key decryption function complimenting Enc( ), with at least quantities m and r being recovered from the result;
(d) checks that the message m is from the first computing entity by checking that:
w=H(C₁(at least m and r))
where H: {0,1}^{n+k}^{₀}→{0,1}^{k}^{₁} and C₁( ) is a deterministic combination function.

17. A method according to claim 16, wherein the function C₁( ) is a concatenation function.

18. A method according to claim 16, wherein the symmetric-key decryption function Dec( ) effects at least the followings operations:
forming a hash of the key w;
forming an exclusive-OR of the hash of w with s.

19. Apparatus for carrying out the method of claim 16.

20. A computer-readable medium storing a computer program arranged to condition a program-controlled computer, when executed by the latter, to carry out the method of claim 16.

21. A method by which a first computing entity having an RSA key pair (N_{A},e_{A}), (N_{A},d_{A}) digitally signs and encrypts a message data string, m, for decryption by a second computing entity having an RSA key pair (N_{B}, e_{B}), (N_{B}, d_{B}), where |N_{A}|=|N_{B}|=k and mε{0,1}ⁿ, and k=n+k₀+k₁ for integers k₀ and k₁ even, the method comprising:
a) selecting an integer rε{0,1}^{k}^{₀},
b) forming the hash ω=H(m∥r) where H: {0,1}^{n+k}^{₀}→{0,1}^{k}^{₁}, and
c) forming the hash s=G(ω)⊕(m∥r) where G: {0,1}^{k}^{₁}→{0,1}^{n+k}^{₀};
steps a) to c) being repeated as necessary to obtain s∥ω≦N_{A}; and then
d) signing by forming c′=(s∥ω)^{d}^{_{A}} mod N_{A}; and, if c′>N_{B},
removing the most significant bit of c′ to obtain a new c′; and then
e) encrypting c′ by forming c=c′^{e}^{_{B}} mod N_{B}.

22. The method as claimed in claim 21 in which r is selected at random.

23. A computer storage medium having stored thereon a computer program readable by a general-purpose computer, the computer program including instructions for said general purpose computer to configure it for implementing the steps of the method of claim 21.

24. A method by which a first computing entity having an RSA key pair (N_{A},e_{A}), (N_{A},d_{A}) digitally signs and encrypts a message data string, m, for decryption by a second computing entity having an RSA key pair (N_{B},e_{B}), (N_{B},d_{B}) where |N_{A}|=|N_{B}|=k and mε{0,1}ⁿ, and k=n+k₀+k₁ for integers k₀ and k₁ even; the method comprising:
a) selecting an integer rε{0,1}^{k}^{₀},
b) forming the hash ω=H(m∥r) where H: {0,1}^{n+k}^{₀}→{0,1}^{k}^{₁}, and
c) forming the hash s=G(ω)⊕(m∥r) where G: {0,1}^{k}^{₁}→{0,1}^{n+k}₀;
steps a) to c) being repeated as necessary to obtain s∥ω≦N_{A} and then
steps a) to c) being repeated as necessary to obtain s∥ω≦N_{A} and then
d) signing by forming c′=(s∥ω)^{d}^{_{A}} mod N_{A};
steps a0 to d) being repeated as necessary to obtain c′<N_{B}, and then
e) encrypting c by forming c=c′^{e}^{_{B}} mod N_{B}.

25. The method as claimed in claim 24 in which r is selected at random.

26. A computer storage medium having stored thereon a computer program readable by a general-purpose computer, the computer program including instructions for said general purpose computer to configure it for implementing the steps of the method of claim 24.
